(19) United States
(12) Patent Application Publication
(10) Pub. No.: US 2016/0171571 A1
(43) Pub. Date: Jun. 16, 2016

(54) PLANNING DEVICE AND PLANNING METHOD

(71) Applicant: FUJITSU LIMITED, Kawasaki-shi (JP)

(72) Inventors: Yuhei UMEDA, Kawasaki (JP); Yoshinobu MATSUI, Kawasaki (JP); Kazuhiro MATSUMOTO, Kawasaki (JP); Hirokazu ANAI, Hachioji (JP); Isamu WATANABE, Kawasaki (JP)

(73) Assignee: FUJITSU LIMITED, Kawasaki (JP)

(21) Appl. No.: 14/940,812

(22) Filed: Nov. 13, 2015

(30) Foreign Application Priority Data
Dec. 10, 2014 (JP) 2014-250311

(51) Int. Cl. G06Q 30/06

(52) U.S. Cl. CPC G06Q 30/0605

(57) ABSTRACT

A planning method for planning to order a product, the planning method being executed by a computer, the planning method includes: generating a predicted value of a demand of the product at each plurality of prices based on a selling price and a number of sales in association with each other for each past sale date; calculating an order quantity that yields a highest profit, for each of the plurality of prices, using the predicted value of the demand of the product at the plurality of prices; storing, for the plurality of prices, the calculated order quantity and a profit in association with each other into a memory; and identifying a combination of a price and an order quantity that yields the highest profit, with reference to the memory.

### CROSS-REFERENCE TO RELATED APPLICATION

This application is based upon and claims the benefit of priority of the prior Japanese Patent Application No. 2014-250311, filed on Dec. 10, 2014, the entire contents of which are incorporated herein by reference.

### FIELD

The embodiments discussed herein are related to techniques for order planning.

### BACKGROUND

There are techniques for determining the order quantity of a product. Such techniques, for example, predict the future quantity demanded of a product from the past sales quantity of the product, and calculate the order quantity of the product with which the chance of the product becoming out of stock is avoided while the stock quantity of the product is controlled. The related-art techniques are disclosed, for example, in Japanese Laid-open Patent Publication No. 2007-172307, Japanese Laid-open Patent Publication No. 2002-297958, and Japanese Laid-open Patent Publication No. 2005-174035.

### SUMMARY

According to an aspect of the invention, a planning method for planning to order a product, the planning method being executed by a computer, the planning method includes: generating a predicted value of a demand of the product at each plurality of prices based on a selling price and a number of sales in association with each other for each past sale date; calculating an order quantity that yields a highest profit, for each of the plurality of prices, using the predicted value of the demand of the product at the plurality of prices; storing, for the plurality of prices, the calculated order quantity and a profit in association with each other into a memory; and identifying a combination of a price and an order quantity that yields the highest profit, with reference to the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of a system configuration;

FIG. 2 is a diagram illustrating an overall configuration of an order plan determination device;

FIG. 3 is a diagram depicting an example of product information;

FIG. 4 is a diagram depicting an example of actual demand information;

FIG. 5 is a flowchart illustrating an example of a procedure of an order plan determination process; and

FIG. 6 is a diagram illustrating a computer that executes an order plan determination program.

### DESCRIPTION OF EMBODIMENTS

Ordering a product in the order quantity calculated by a related-art technique does not yield a high profit in some cases.

The quantity demanded of a product varies in accordance with a price at which that product is sold. The per-piece profit when a product is sold also varies in accordance with the price of that product. The price of a product is determined by a person in charge from their experience or the like. Therefore, even when a product in the order quantity calculated by a related-art technique is ordered, the order quantity and the price that yield a high profit are not able to be determined in some cases.

In one aspect, an object of the present disclosure is to obtain an order quantity and a price that yield a high profit.

Hereinafter, embodiments of an order plan determination device, an order plan determination method, and an order plan determination program will be described in detail with reference to the accompanying drawings. It is to be noted that the present disclosure is not limited by the embodiments. The embodiments may be combined as appropriate to the extent that processing contents do not contradict each other.

### First Embodiment

### System Configuration

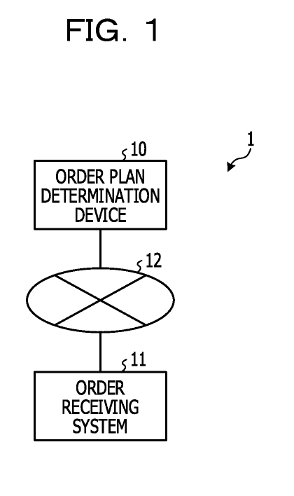

First, an example of a system that places an order by using an order plan determination device according to a first embodiment will be described. FIG. 1 is a diagram for explaining an example of a system configuration. As illustrated in FIG. 1, a system 1 includes an order plan determination device 10 and an order receiving system 11. The order plan determination device 10 and the order receiving system 11 are communicatively coupled over a network 12 to be capable of exchanging various types of information. As one form of such the network 12, any type of communication network, regardless of being wired or wireless, including a network of mobile communication such as mobile phone communication, the Internet, a local area network (LAN), or a virtual private network (VPN) may be employed.

The order receiving system 11 is a system for managing product ordering and stocks. For example, the order receiving system 11 is a system that operates on one or a plurality of server computers. The order receiving system 11 stores master data in which the cost prices of products and the like are set. In the order receiving system 11, sales information of products and delivery information of products are uploaded from point of sale (POS) systems of shops. The order receiving system 11 manages the current stock quantities of products based on the uploaded sales information of the products and delivery information of the products. The order receiving system 11 also performs processing regarding product ordering. For example, the order receiving system 11 receives order data indicating the order quantity per product and sends the order data to a supplier of the product.

The order plan determination device 10 is a device that determines an order plan for a product. For example, the order plan determination device 10 determines an optimum order quantity for a product to be ordered and the price of the product for a given ordering period and outputs an order plan for the ordering period. In the present embodiment, description is given of the case where, under condition that the ordering period is three days, that is, today, tomorrow, and the day after tomorrow, the order plan determination device 10 outputs an order plan indicating the order quantities of three times, once per day. The order plan determination device 10 is, for example, a computer such as a personal computer or a server computer. The order plan determination device 10 may be implemented as one computer or may be implemented by a plurality of computers. Note that, in the present embodiment, description is given by way of example of the case where the order plan determination device 10 is one computer.

[Configuration of Order Plan Determination Device]

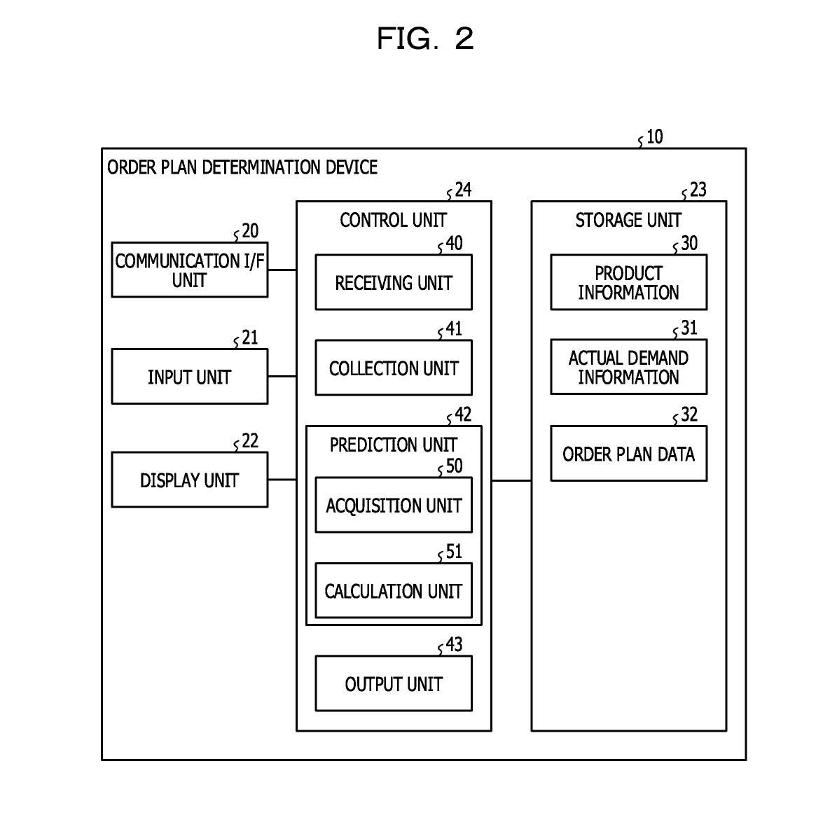

The order plan determination device 10 according to the first embodiment will be described. FIG. 2 is a diagram illustrating an overall configuration of an order plan determination device. As illustrated in FIG. 2, the order plan determination device 10 includes a communication interface (I/F) unit 20, an input unit 21, a display unit 22, a storage unit 23, and a control unit 24. Note that the order plan determination device 10 may include other components other than the above components.

The communication I/F unit 20 is an interface that controls communication with other devices. As the communication I/F unit 20, a network interface card such as a LAN card may be employed.

The communication I/F unit 20 transmits and receives various kinds of information from another device over the network 12. For example, the communication I/F unit 20, which is capable of transmitting and receiving various kinds of information from the order receiving system 11, transmits and receives various kinds of information on a product to be ordered from the order receiving system 11.

The input unit 21 is an input device that inputs various kinds of information. As the input unit 21, an input device that receives operations, such as a mouse or a keyboard, is mentioned. The input unit 21 receives input of various kinds of information. For example, the input unit 21 receives input of various kinds of operations regarding determination of an order quantity. The input unit 21 receives input of an operation from a user and inputs operation information indicating the operation of the received input, to the control unit 24.

The display unit 22 is a display device that displays various kinds of information. As the display unit 22, a display device, such as a liquid crystal display (LCD) or a cathode ray tube (CRT), is mentioned. The display unit 22 displays various kinds of information. For example, the display unit 22 displays various screens, such as a product specification screen for specifying a product to be ordered and an order plan display screen on which the price and the order quantity of a product to be ordered are displayed.

The storage unit 23 is a storage device such as a hard disk, a solid state drive (SSD), or an optical disk. Note that the storage unit 23 may be a rewritable semiconductor memory, such as a random access memory (RAM), a flash memory, or a nonvolatile static random access memory (NVSRAM).

The storage unit 23 stores an operating system (OS) and various types of programs executed on the control unit 24. For example, the storage unit 23 stores various types of programs for use for determination of an order plan. The storage unit 23 further stores various kinds of data for use by a program executed by the control unit 24. For example, the storage unit 23 stores product information 30, actual demand information 31, and order plan data 32.

The product information 30 is data that contains various kinds of information on a product to be ordered. The product information 30 contains various kinds of information for use for determination of an order quantity, such as the product code of a product to be ordered, the current stock quantity of the product to be ordered, and the cost price of the product to be ordered. Various kinds of information contained in the product information 30 may be updated as appropriate. In the present embodiment, various kinds of information contained in the product information 30 are updated one by one at each time at which an order is placed. For example, the current stock quantity is updated at each time at which an order is placed.

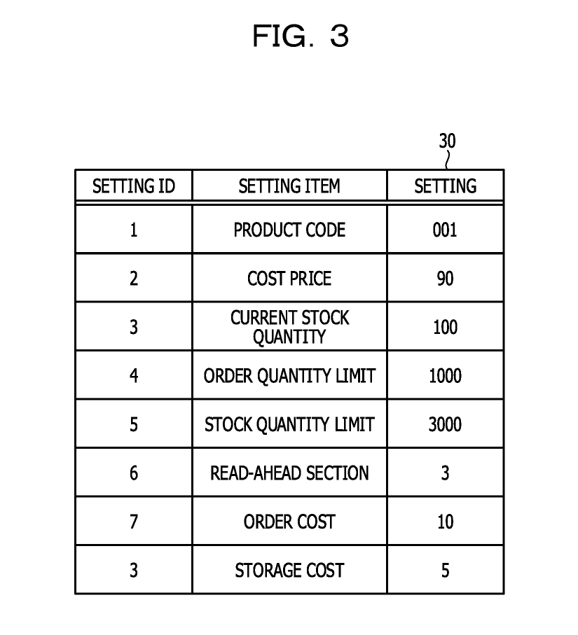

FIG. 3 is a diagram depicting an example of product information. The product information 30 includes fields of setting identification (ID), setting item, and setting. The setting ID field is an area in which identification numbers identifying setting items are stored. For various setting items, identification numbers identifying the setting items, respectively, are defined. In the setting ID field, identification numbers in accordance with the setting items are stored. The setting item field is an area in which the names of setting items are stored. The setting field is an area in which setting details regarding setting items are stored. In the example of FIG. 3, a setting ID “1” indicates that the product code of a product to be ordered is the setting item, and a product code “001” is set as the setting details. A setting ID “2” indicates that the cost price of the product to be ordered is the setting item, and a cost price of “90” yen is set as the setting details. A setting ID “3” indicates that the current stock quantity of the product to be ordered is the setting item, and a stock quantity of “100” pieces is set as the setting details. A setting ID “4” indicates that an order quantity limit representing the upper limit of an order quantity of the product to be ordered is the setting item, and an order quantity limit of “1000” pieces is set as the setting details. A setting ID “5” indicates that a stock quantity limit representing the upper limit of a stock quantity of the product to be ordered is the setting item, and a stock quantity limit of “3000” pieces is set as the setting details. A setting ID “6” indicates that a read-ahead section representing a period during which the demand for the product to be ordered is predicted, as the setting item, and a read-ahead section “3” is set as the setting details. The read-ahead section “3” indicates that the demand for the product to be ordered is predicted for three days, that is, today, tomorrow, and the day after tomorrow. A setting ID “7” indicates that the order cost per piece of the product to be ordered is the setting item, and an order cost of “10” yen is set as the setting details. A setting ID “8” indicates that the storage cost of stock per piece of the product to be ordered is the setting item, and a storage cost of “5” yen is set as the setting details.

Referring back to FIG. 2, the actual demand information 31 is data that contains information on the past demand for a product to be ordered. For example, the actual demand information 31 contains the quantities demanded in the past and the selling prices of a product to be ordered.

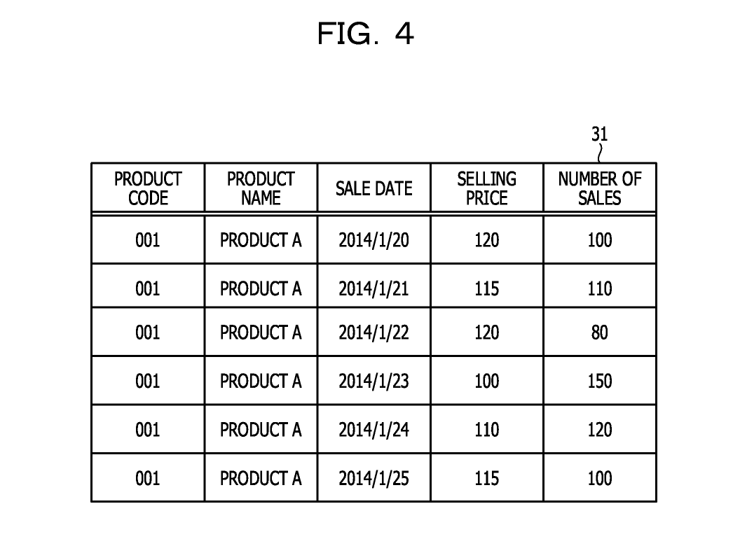

FIG. 4 is a diagram depicting an example of actual demand information. The actual demand information 31 includes fields of product code, product name, sale date, selling price, and the number of sales. The product code field is an area in which the product codes of products are stored. The product name field is an area in which the product names of products are stored. The sale date field is an area in which dates on which products were sold are stored. The selling price field is an area in which prices at which products were sold are stored. The number of sales field is an area in which the numbers of sales of products as the quantity demanded are stored. The example of FIG. 4 indicates that the product of a product code “001” has a product name “product A”, the price of the product sold on the sale date “2014/1/20” is “120”, and the number of sales is “100”.

Referring back to FIG. 2, the order plan data 32 is data that contains information on an order plan of a product to be ordered. For example, the order plan data 32 contains combinations of the prices and the order quantities in an ordering period of a product to be ordered.

The control unit 24 is a device that controls the order plan determination device 10. As the control unit 24, an electronic circuit, such as a central processing unit (CPU) or a micro processing unit (MPU), or an integrated circuit, such as an application specific integrated circuit (ASIC) or a field programmable gate array (FPGA), is employed. The control unit 24 includes an internal memory for storing programs defining various processing procedures and control data and executes various processes using the programs and the control data. The control unit 24 functions as various types of processing units when various types of programs run. For example, the control unit 24 includes a receiving unit 40, a collection unit 41, a prediction unit 42, and an output unit 43.

The receiving unit 40 receives, as input, various kinds of information on ordering. For example, the receiving unit 40 receives a specification of a product to be ordered. For example, the receiving unit 40 causes a product specification screen, which is not illustrated in the drawing, to be displayed and receives a specification of a product to be ordered from the product specification screen. The receiving unit 40 may receive a specification of a product to be ordered through input of the product code. The receiving unit 40 may also receive a specification of a product to be ordered by causing the display unit 22 to display categories into which products are classified, and causing the display unit 22 to display products of a selected category to allow the product to be selected. The receiving unit 40 causes the product code of the specified product to be ordered to be contained in the product information 30.

The collection unit 41 collects various kinds of information. For example, the collection unit 41 collects various kinds of information on a product to be ordered specified on the receiving unit 40. For example, the collection unit 41 collects the cost price, the current stock quantity, the upper limit of an order quantity, the upper limit of a stock quantity, the read-ahead section, the order cost, the storage cost, and so on of a product to be ordered, from the order receiving system 11. The collection unit 41 causes the collected various kinds of information to be contained in the product information 30. For example, the collection unit 41 causes the cost price, the current stock quantity, the upper limit of an order quantity, the upper limit of a stock quantity, the read-ahead section, the order cost, the storage cost of a product to be ordered to be contained in the product information 30. The collection unit 41 also collects a quantity demanded in the past of a product to be ordered from the order receiving system 11 and stores this quantity demanded in the actual demand information 31. Although, in the present embodiment, the collection unit 41 collects information from the order receiving system 11 for the product information 30 and the actual demand information 31 and stores the information, the way for collecting and storing information is not limited to this way. Another system or the administrator may store the product information 30 and the actual demand information 31. Some or all of the various kinds of information of the product information 30 may be received as input by the receiving unit 40. For example, the cost price and the current stock quantity of a product may be collected from the order receiving system 11. The upper limit of an order quantity, the upper limit of a stock quantity, the read-ahead section, the order cost, and the storage cost of a product to be ordered may be received as input by the receiving unit 40.

The prediction unit 42 performs various types of prediction. For example, the prediction unit 42 predicts demands in accordance with prices and solves an optimization problem in relation to the predicted demands, thereby predicting the order quantity and the price of a product that yield a high profit. The prediction unit 42 includes an acquisition unit 50 and a calculation unit 51.

The acquisition unit 50 performs various types of acquisition. For example, the acquisition unit 50 acquires a predicted value of the demand for a product at each price. The quantity demanded of a product varies in accordance with the price of the product. Therefore, in the present embodiment, based on the prices in the past and the numbers of sales at those prices contained of a product to be ordered in the actual demand information 31, the acquisition unit 50 predicts demands in accordance with prices in the ordering period, thereby acquiring a predicted value of the demand for the product at each price. For example, the acquisition unit 50 performs time series analysis using an autoregressive integrated moving average (ARIMA) model or the like to predict demands in accordance with prices. Note that the technique for predicting demands is not limited to this and may be any technique. For example, using a support vector machine or the like, the demands in the past are learned and the quantity demanded may be predicted. Although, in the present embodiment, the case where the acquisition unit 50 predicts demands in accordance with prices in the ordering period is described, the present disclosure is not limited to this case. For example, results obtained by predicting demands in the ordering period at various prices for a product to be ordered are stored in advance as predicted demand information in the storage unit 23, and the acquisition unit 50 may acquire a predicted value of the demand for a product at each price from the predicted demand information. Prediction of the demand in the ordering period may be performed by another information processing device. The acquisition unit 50 may acquire prediction results from the other information processing device.

Here, an exemplary prediction technique is demonstrated. For example, the quantity demanded d(k+1) predicted for a product to be ordered in a (k+1)-th term is generalized and expressed, for example, as in the following expression (1).

d(k+1)=f[d(k),d(k−1), . . . ,p(k+1),p(k),p(k−1) . . . ] (1)
where, d(k) is the demand for a product to be ordered in a k-th term, and p(k+1) is the price of the product to be ordered in the (k+1)-th term.

When, assuming that the current term is the k-th term, prediction in the (k+1)-th term is performed, d(k), d(k−1), . . . , and p(k), p(k−1), . . . are the values of actual sales obtained from the actual demand information 31, respectively. In this case, p(k+1) is the price at which the product to be ordered is planned to be sold in the (k+1)-th term.

A function f is a function with which a demand and a price of a product are input, a computation using parameters is performed on the demand and the price of a product, and a predicted demand is output. The function f varies in terms of the degree and the number of parameters according to the prediction model. The function f also varies, according to the prediction model as well as the prediction accuracy, in terms of the number of terms for which the demands and the prices of a product are input. With regard to the function f, the function f for use for the prediction model is defined, and fitting is performed using the past demands and prices of a product to be ordered contained in the actual demand information 31, thus enabling the values of parameters of the function f for the prediction model to be set. For example, predicting the demand in the (k+1)-th term by expression (1) and fitting performed using a comparison of the predicted demand with the actual demand in the (k+1)-th term are repeated for a plurality of terms. Thereby, parameters that lead to the smallest error in the predicted demand are determined. The fitting may be performed in advance. The acquisition unit 50 may perform fitting using the past demands and prices of a product to be ordered contained in the actual demand information 31.

The acquisition unit 50 predicts and acquires a predicted value of the demand for the product at each price in the ordering period. For example, the acquisition unit 50 predicts a demand that will occur one term later, based on the past demands and price histories of a product to be ordered that are contained in the actual demand information 31. Then, the prediction unit 42 predicts a demand that will occur two terms later using the past demands and price histories as well as the predicted result of the demand in one term later and repeats such prediction, thus obtaining a demand in the ordering period. In the present embodiment, a predicted value of the demand for the product is acquired at each of prices of three days, that is, today, tomorrow, and the day after tomorrow. For example, when expression (1) is used, the acquisition unit 50 predicts a demand in accordance with the price of today, using the past demands and prices of a product to be ordered. The acquisition unit 50 then predicts a demand in accordance with the price of tomorrow, using the past demands and prices of the product to be ordered as well as the demand in accordance with the price of today. The acquisition unit 50 then predicts a demand in accordance with the price of the day after tomorrow, using the past demands and prices of the product to be ordered as well as the demands in accordance with the prices of today and tomorrow.

Although, in the present embodiment, the case where the demand is predicted day by day is described, the expression of a prediction model may be defined so that the demands of a plurality of days are predicted all together. For example, the expression may be defined so as to calculate the demands in accordance with the prices of three days, that is, today, tomorrow, and the day after tomorrow, and perform fitting to determine parameters. In addition, prediction of the demands may be performed taking into account other factors. For example, the demands may be predicted using a prediction model to which the day of week, weather, events, and the like are added.

The calculation unit 51 calculates various values. For example, using a predicted value of the demand for the product at each price acquired by the acquisition unit 50, the calculation unit 51 calculates the price and the order quantity of the product that yield the highest profit. For example, the calculation unit 51 solves an optimization problem of an objective function where the price and the order quantity are inputs and the profit is an output, thereby calculating a combination of the price and the order quantity of the product that yields the highest profit.

Here, description is given of an objective function and constraints used for the optimization problem.

The calculation unit 51 calculates a stock quantity predicted of a product to be ordered on each date in the ordering period. For example, when a product ordered in some term is delivered in the next term, a stock quantity s (k+1) in a (k+1)-th term is given by the following expression (2).

s(k+1)=s(k)+u(k+1)−d(k+1) (2)

where, s(k) is the stock quantity in the k-th term,

u(k+1) is the order quantity in the (k+1)-th term, and

d(k+1) is the quantity demanded in the (k+1)-th term.

For example, it is assumed that the ordering period is three days, and the prices and the order quantities of three days are (p1, u1), (p2, u2), and (p3, u3). It is also assumed that, when the prices of a product to be ordered for three days are p1, p2, and p3, the demands are d1, d2, and d3. It is also assumed that the current stock quantity of the product to be ordered is s0. In this case, a stock prediction s1 obtained one day later is calculated from s1=s0+u1−d1. A stock prediction s2 obtained two days later is calculated from s2=s1+u2−d2. A stock prediction s3 obtained three days later is calculated from s3=s2+u3−d3.

The calculation unit 51 calculates the profits of individual days in the ordering period. For example, assuming that the cost price per piece of the product is cp, a profit m(k) in the k-th term is given by the following expression (3). The per-piece cost price cp is acquired from the product information 30.

m(k)=d(k)×(p(k)−cp) (3)

where p(k) is the price in the k-th term.

For example, it is assumed that the profits of three days, which are the ordering period, are m1, m2, and m3. The profit m1 obtained one day later is calculated from m1=d1×(p1−cp). The profit m2 obtained two days later is calculated from m2=d2×(p2−cp). The profit m3 obtained three days later is calculated from m3=d3×(p3−cp).

The profit of an ordering period has a value obtained by adding together the profits of all the days of the ordering period. For example, the total profit of three days, which are the ordering profit, varies in accordance with the prices of three days, p1, p2, and p3, and the demands of three days, d1, d2, and d3. That is, the demands d1, d2, and d3 vary in accordance with the prices p1, p2, and p3 and the order quantities u1, u2, and u3. Consequently, the profit of the ordering period is represented as in the following expression (4).

b(p1,p2,p3,u1,u2,u3)=m1+m2+m3 (4)

Note that the technique for calculating a profit is not limited to the technique described above and various techniques may be used. For example, the profit may be calculated taking into account various costs such as the stock storage cost and the order cost. The stock quantity also may be calculated taking into account a period from the time at which a product is ordered to the time at which the product arrives, or the like. The period from the ordering time to the arrival time is also called a lead time.

For example, the calculation unit 51 calculates the order cost of each day of the ordering period. For example, when the order cost including a list of charges, a delivery charge, a fee, or the like per piece of a product to be ordered is oc, an order cost c(k) of the k-th term is given by the following expression (5). This per-piece order cost oc is acquired from the settings of the order cost of the product information 30.

c(k)=oc×u(k) (5)

For example, it is assumed that the order costs of three days, which are the ordering period, are c1, c2, and c3. The order cost c1 obtained one day later is calculated from c1=oc×u1. The order cost c2 obtained two days later is calculated from c2=oc×u2. The order cost c3 obtained three days later is calculated from c3=oc×u3.

The calculation unit 51 also calculates the storage costs of a product of individual days of the ordering period. For example, when a storage cost, including charges for the use of a location and charges for storage, per piece of a product to be ordered is cc, a storage cost sc (k) of the k-th term is given by the following expression (6). This per-piece storage cost cc is acquired from the setting of the storage cost of the product information 30.

sc(k)=cc×s(k) (6)

For example, it is assumed that the storage costs of three days, which are the ordering period, are sc1, sc2, and sc3. The storage cost sc1 obtained one day later is calculated from sc1=cc×s1. The storage cost sc2 obtained two days later is calculated from sc2=cc×s2. The storage cost sc3 obtained three days later is calculated from sc3=cc×s3.

As a result, the profit including the order cost and the storage cost of the product is represented as in the following expression (7).

b(p1,p2,p3,u1,u2,u3)=m1+m2+m3−c1−c2−c3−sc1−sc2−sc3 (7)

As represented in expression (4) and expression (7), the profit in the ordering period is a function where the price and the order quantity are inputs and the profit is an output.

There are some cases where a product has an upper limit on the order quantity for a reason related to the manufacturer, delivery, or the like. In the present embodiment, it is assumed that an upper limit U is placed on the order quantities u1, u2, and u3 of three days, which are the ordering period, as represented by the following expression (8).

0≦u1,u2,u3≦U (8)

Stock-outs in which a product is out of stock could result in opportunity losses, and therefore it is preferable that the occurrence of a stock-out be avoided. In order to avoid the occurrence of a stock-out, the stock quantity of an individual day of the ordering period may be greater than or equal to the demand of that day. In the present embodiment, the stock predictions s1, s2, and s3 of three days, which are the ordering period, are greater than or equal to the demands d1, d2, and d3, respectively, as in the following expression (9).

s1≧d1

s2≧d2

s3≧d3 (9)

Under various kinds of constraints, using a predicted value of the demand for the product at each price acquired, the calculation unit 51 solves an optimization problem of an objective function where the price and the order quantity are inputs and the profit is an output, thereby calculating a combination of the price and the order quantity of the product that yields the highest profit. For example, the calculation unit 51 solves an optimization problem, with an objective function of the above expression (4) or expression (7), subject to the limitation on the order quantity represented by the above expression (8) and the limitation on the stock quantity represented by the above expression (9), as constraints, and thereby calculates the price and the order quantity of the product that yield the highest profit. For example, the prediction unit 42 acquires a predicted value of the demand for the product at each price, using the price in each term of the ordering period as a given initial value, by using the acquisition unit 50. The initial value may be set to be fixed, may be set by the user, or may be the latest sales price. In the prediction unit 42, under the conditions of the price in each term of the ordering period and the demand for the product in accordance with the price, the order quantity of each term is varied positively or negatively from its given initial value and a profit is determined by the calculation unit 51. This initial value also may be set to be fixed, may be set by the user, or may be the latest order quantity. If the calculated profit becomes higher, the calculation unit 51 varies the order quantity in each term so that the profit becomes higher, and determines an optimum order quantity in each term where the profit has a maximum value and no longer increases.

In the prediction unit 42, the price of a product in each term of the ordering period is varied positively or negatively, and a predicted value of the demand for the product at each price is acquired by the acquisition unit 50. In the prediction unit 42, then, the determination of an optimal order quantity in each term, where the profit has a maximum value at the varied price, is repeated by the calculation unit 51. In the prediction unit 42, if, when the price in each term of the ordering period is varied, the calculated maximum profit becomes higher, varying the price in each term so that the maximum profit becomes higher is repeated. Thus, a combination of the price and the order quantity of the product in each term of the ordering period that yields the highest profit is obtained. The calculation unit 51 stores the calculated combination of the price and the order quantity in each term in the order plan data 32.

Note that the constraint is not limited to the constraint described above, various constraints may be used. For example, in shops, for the purpose of selling a product at a lower price than neighboring competitors, an upper limit on the price is set in some cases. In shops, for the purpose of maintaining the value of a product, a lower limit of possible prices is sometimes set. For this reason, a constraint on the price range is sometimes placed. The constraint on the price range is represented, for example, as in the following expression (10).

lb(k)≦p(k)≦ub(k) (10)
where, lb(k) is the lower limit of a planned sales price in the k-th term, and ub(k) is the upper limit of the planned sales price in the k-th term.

In shops, for the purpose of avoiding rapid variations in price or violent fluctuations, the upper and lower limits are sometimes imposed on a difference between the price of a day in question and the price of the day preceding that day. For this reason, a constraint is sometimes placed on the possible price variation. The constraint on the possible price variation is represented, for example, as in the following expression (11).

lb_{d}(k)≦p(k)−p(k−1)≦ub_{d}(k) (11)
where, lb_{d}(k) is the lower limit of a price variation of the k-th term from the price of its preceding term, and ub_{d}(k) is the upper limit of a price variation of the k-th term from the price of its preceding term.

Additionally, for the purpose of suppressing a rapid variation in price, instead of adding a constraint on the possible price variation, a variation penalty as in the following expression (12) may be given to the objective function.

α(p(k)−p(k−1))² (12)

where α is a weighting parameter.

The variation penalty has a larger value as the variation in price is larger. For example, an inequality constraint is not placed, and the objective function may be changed from the profit function b represented by the above expression (4) or expression (7) to the following expression (13).

$$b - {\sum }_{k = 0}^{N - 1} ( {α ( p ( k ) - p ( k - 1 ) )}^{2} ) \qquad ( 13 )$$

where N is a prediction section.

The prediction section is acquired from the setting of the read-ahead section of the product information 30.

As represented in expression (13), the variation penalty is subtracted from the profit function b. As a result, the value calculated from expression (13) is larger as the variation in price is smaller. This causes an order with a small price variation to be more likely to be a solution when the calculation unit 51 solves the optimization problem. Thus, a rapid variation in price is suppressed.

In shops, the day of the week or the like when the price changes is sometimes predetermined. For this reason, a constraint is sometimes placed on a time when the price is capable of changing. If the day of the week or the like when the price changes is predetermined, the constraint on a time when the price is capable of changing is represented, for example, as below.

When the date of price change is fixed and when the date of price change is not included in a prediction period, the constraint is represented as in the following expression (14).

p(0)=p(1)= . . . =p(N−1) (14)
When the date of price change is fixed and when the date of price change (=d) is included in the prediction period, the constraint is represented as in the following expression (15).

p(0)=p(1)= . . . =p(d−1),p(d)= . . . =p(N−1) (15)

In shops, the change interval at which the price changes is sometimes predetermined. For this reason, a constraint is sometimes placed on a time when the price is capable of changing. When the interval at which the price changes is predetermined, the constraint on a time when the price is capable of changing is represented as below.

When the change interval (=sp) is fixed and when the price may change the first day (the day in question), the constraint is represented as in the following expression (16).

p(0)=p(1)= . . . =p(sp−1),

p(sp)= . . . =p(2×sp−1) (16)
When the price change interval is fixed and when the first day is at a midpoint of the change interval (the m-th day in the sp period), the constraint is represented as in the following expression (17).

p(−1)=p(0)= . . . =p(sp−m−1),

p(sp−m)= . . . =p(2×sp−m−1) (17)

In shops, the price sometimes remains the same for more than a certain number of consecutive days. For this reason, a constraint is sometimes placed on a time when the price is capable of changing. When the price remains the same for more than a certain number of consecutive days, a constraint on a time when the price is capable of changing is represented as below.

For example, if, assuming that the prediction period is five days and the same price period is three days, the product was already sold at the same price for the previous three days, the constraint is represented as in the following expression (18).

p(−1)≠p(0)=p(1)=p(2),p(3)=p(4) or

p(−1)≠p(0)=p(1)=p(2)=p(3) or

p(−1)=(0)≠p(1)=p(2)=p(3) or

p(−1)=(0)=p(1)≠p(2)=p(3)=p(4) or

p(−1)=(0)=p(1)=p(2)≠p(3)=p(4) or

p(−1)=(0)=p(1)=p(2)=p(3) (18)

For example, if, assuming the prediction period is five days and the same price period is three days, the product was sold at the same price for the previous two days and, three days before, was sold at a different price, the constraint is represented as in the following expression (19).

p(−1)=p(0)≠p(1)=p(2)=p(3) or

p(−1)=p(0)=p(1)≠p(2)=p(3)=p(4) or

p(−1)=(0)=p(1)=p(2)≠p(3)=p(4) or

p(−1)=(0)=p(1)=p(2)=p(3) (19)

For example, if, assuming that the prediction period is five days and the same price period is three days, the price changed one day before, the constraint is represented as in the following expression (20).

p(−1)=p(0)=p(1)≠p(2)=p(3)=p(4) or

p(−1)=p(0)=p(1)=p(2)≠p(3)=p(4) or

p(−1)=(0)=p(1)=p(2)=p(3) (20)

In accordance with the limitations on the prices of shops, the prediction unit 42 adds any one or a plurality of constrains on the price range, the possible price variation, and a time when the price is capable of changing, as represented in expressions (10) to (20), to the optimization problem and solves this problem. Thus, the prediction unit 42 may determine the price and the order quantity of the product that reflect limitations on actual shops and that yield the highest profit.

The output unit 43 performs various kinds of output. For example, the output unit 43 outputs, to the display unit 22, the order plan display screen displaying a combination of the price and the order quantity, in each term of the ordering period, contained in the order plan data 32. The combination of the price and the order quantity yields the highest profit of a product to be ordered. Note that the output unit 43 may output a combination of the price and the order quantity of the product that yields the highest profit to the order receiving system 11, performing automatic ordering.

[Flow of Process]

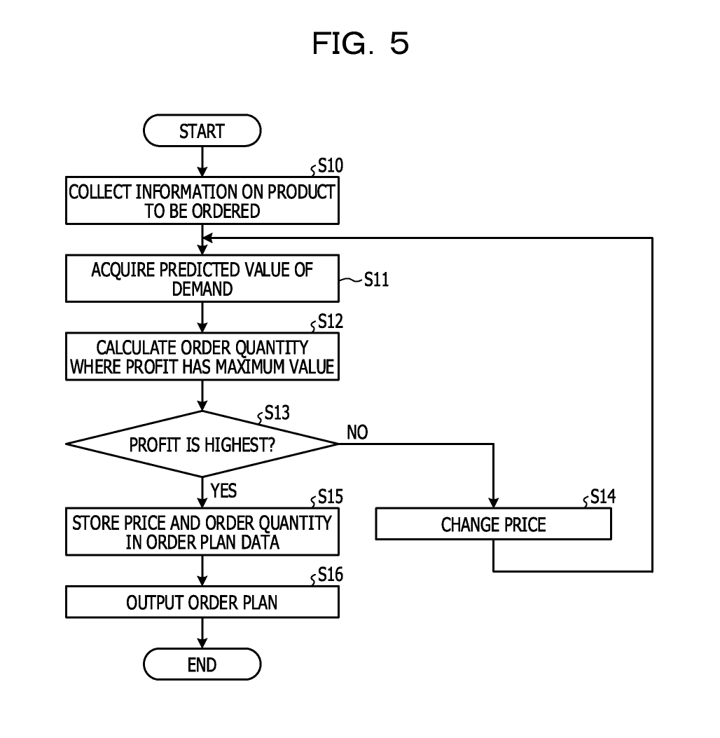

Next, the flow of an order plan determination process in which the order plan determination device 10 determines an order plan will be described. FIG. 5 is a flowchart illustrating an example of a procedure of the order plan determination process. The order plan determination process is executed at a given time, for example, at a time at which a specification of a product to be ordered is received by the receiving unit 40.

As illustrated in FIG. 5, the collection unit 41 collects various kinds of information on a product to be ordered and stores the information in the storage unit 23 (S10). For example, the collection unit 41 collects the price at which the product to be ordered was sold, the cost price, the current stock quantity from the order receiving system 11 and stores the collected price, cost price, and current stock quantity in the product information 30. The collection unit 41 also collects the past demand quantity of the product to be ordered, in each term, from the order receiving system 11 and stores the past demand quantity of the product to be ordered in the actual demand information 31.

The acquisition unit 50 acquires a predicted value of the demand for the product at each price in the ordering period (S11).

The calculation unit 51 solves an optimization problem of an objective function based on the predicted value of the demand for the product at each price, thereby calculating the order quantity in each term where the profit has a maximum value at the price (S12).

The calculation unit 51 determines whether or not the maximum profit obtained when the order quantity in each term where the profit has a maximum value is calculated is the highest profit (S13). For example, the calculation unit 51 determines whether or not the profit having a maximum value at the price is highest, while, from the price at which the above optimum order quantity in each term is calculated, varying the price positively and negatively and calculating optimum order quantities in each term at varied prices. If the profit is not highest (No in S13), the acquisition unit 50 varies the price in each term so that the maximum profit becomes higher (S14) and proceeds to S11 described above.

On the other hand, if the profit is highest (Yes in S13), the calculation unit 51 stores a combination of the calculated price and order quantity in each term in the order plan data 32 (S15). The output unit 43 outputs an order plan display screen displaying the price and order quantity of the product to be ordered contained in the order plan data 32, to the display unit 22 (S16) and completes the process.

[Advantages]

As described above, the order plan determination device 10 according to the present embodiment acquires a predicted value of the demand for the product at each price. The order plan determination device 10 solves an optimization problem of an objective function where the price and the order quantity are inputs and the profit is an output, using the predicted value of the demand for the product at each price acquired, thereby calculating a combination of the price and the order quantity of the product that yields the highest profit. Thus, the order plan determination device 10 may obtain the order quantity and the price that lead to a high profit.

The order plan determination device 10 according to the present embodiment also may acquire a predicted value of the demand for the product at each price through prediction using a given predication model based on the past price and the number of sales at the price of the product. Thus, the order plan determination device 10 may acquire an accurate predicted value of the demand.

The order plan determination device 10 according to the present embodiment also solves an optimization problem subject to any one or a plurality of the price range, the possible price variation, and a time when the price is capable of changing, as constraints, thereby calculating a combination of the price and the order quantity of the product that yields the highest profit. Thus, the order plan determination device 10 may obtain the order quantity and the price that reflect the limitations on actual shops and yield a high profit.

### Second Embodiment

The embodiment related to the device of the present disclosure has been described. However, the technique of the present disclosure may be carried out in various different forms other than the embodiment described above. Other embodiments included in the present disclosure will be described below.

For example, although, in the above embodiment, the case where the expression of adding together the profits of individual days is an objective function has been described in expression (4) or expression (7) described above, the present disclosure is not limited to this case. The profit tends to increase in accordance with the sales volume. Accordingly, for example, using, as the objective function, an expression where, instead of the profits of individual days, the sales volumes of individual days are added together, a combination of the price and the order quantity of the product that achieves the largest output of the objective function may be calculated.

Although, in the above embodiment, the case where one cost price of a product is used has been described, the present disclosure is not limited to this case. The cost price of a product may vary day by day or in accordance with the order quantity. For example, when single-piece ordering, in which a product is ordered piece by piece, and lot ordering, in which a product is ordered in lots each including a given number of pieces, are available, the total of the prices of the single-piece ordering and the lot ordering is divided by the order quantity. This gives the cost price per piece of the product. The cost, the order, and the stock limit, in addition to the cost price, may vary day by day.

The elements of each device illustrated in the drawings are functionally conceptual and do not have to be physically configured as illustrated. That is, the specific configurations of distribution and integration of each device are not limited to those illustrated in the drawings, and each device may be configured by functionally or physically distributing and integrating the entirety or part of the device in arbitrary units. For example, processing units of the receiving unit 40, the collection unit 41, the prediction unit 42 (the acquisition unit 50 and the calculation unit 51), and the output unit 43 may be appropriately integrated. The processing of the processing units may be appropriately divided into processing of a plurality of processing units. Furthermore, all or arbitrary part of the processing functions performed by processing units may be realized by a CPU and programs analyzed and executed by that CPU or may be implemented as hardware using wired logic.

[Order Plan Determination Program]

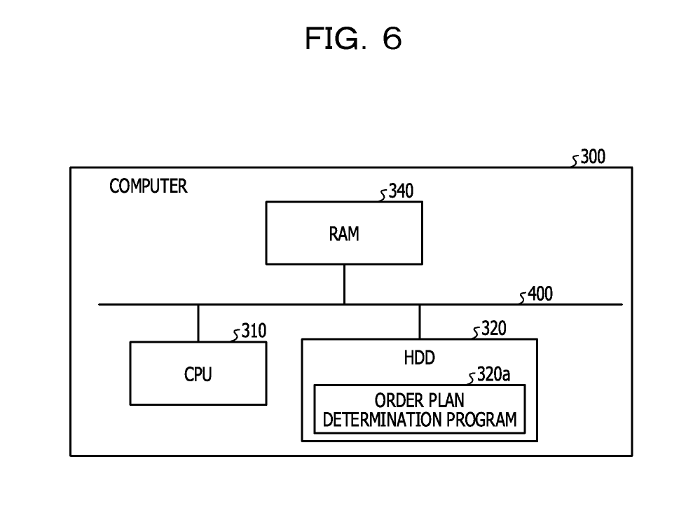

Various kinds of processing described in the above embodiment may be realized by executing a program prepared in advance on a computer system, such as a personal computer or a work station. An example of a computer system that executes a program having functions similar to those in the above embodiment will be described below. FIG. 6 is a diagram illustrating a computer that executes an order plan determination program.

As illustrated in FIG. 6, a computer 300 includes a central processing unit (CPU) 310, a hard disk drive (HDD) 320, and a random access memory (RAM) 340. These units 300 to 340 are coupled via a bus 400.

In the HDD 320, an order plan determination program 320a that performs functions similar to those of the receiving unit 40, the collection unit 41, the prediction unit 42, and the output unit 43 is stored in advance. The order plan determination program 320a may be divided as appropriate.

The HDD 320 also stores various kinds of information. For example, the HDD 320 stores an OS and various kinds of data used for determination of order quantities.

Then, the CPU 310 reads and executes the order plan determination program 320a from the HDD 320 to perform operations similar to those of the processing units of the above embodiment. That is, the order plan determination program 320a performs operations similar to those of the receiving unit 40, the collection unit 41, the prediction unit 42, and the output unit 43.

Note that the order plan determination program 320a mentioned above does not have to be stored from the beginning in the HDD 320.

For example, the program is stored in a “portable physical medium” such as a flexible disk (FD), a compact disk read-only memory (CD-ROM), a digital versatile disk (DVD), a magneto-optical disk, or an IC card, which is inserted into the computer 300. Then, the computer 300 may read and execute a program from the medium.

Furthermore, a program is stored in “another computer (or server)” or the like coupled via a public line, the Internet, a LAN, or a WAN to the computer 300. Then, the computer 300 may read and execute the program from the other computer or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A planning method for planning to order a product, the planning method being executed by a computer, the planning method comprising:
generating a predicted value of a demand of the product at each plurality of prices based on a selling price and a number of sales in association with each other for each past sale date;
calculating an order quantity that yields a highest profit, for each of the plurality of prices, using the predicted value of the demand of the product at the plurality of prices;
storing, for the plurality of prices, the calculated order quantity and a profit in association with each other into a memory; and
identifying a combination of a price and an order quantity that yields the highest profit, with reference to the memory.

2. The planning method according to claim 1, wherein the combination is calculated by solving an optimization problem of an objective function where the order quantity at each of the plurality of prices stored in the memory is an input and the profit is an output.

3. The planning method according to claim 2, wherein the combination is calculated by solving the optimization problem subject to at least one of a price range, a possible price variation, and a time when a price is capable of changing, as a constraint.

4. The planning method according to claim 1, wherein the predicted value is computed using a specific prediction model.

5. A non-transitory storage medium storing a planning program, for planning to order a product, which causes a computer to execute a process, the process comprising:
generating a predicted value of a demand of the product at each plurality of prices based on a selling price and a number of sales in association with each other for each past sale date;
calculating an order quantity that yields a highest profit, for each of the plurality of prices, using the predicted value of the demand of the product at the plurality of prices;
storing, for the plurality of prices, the calculated order quantity and a profit in association with each other into a memory; and
identifying a combination of a price and an order quantity that yields the highest profit, with reference to the memory.

6. The non-transitory storage medium according to claim 5, wherein the combination is calculated by solving an optimization problem of an objective function where the order quantity at each of the plurality of prices stored in the memory is an input and the profit is an output.

7. The non-transitory storage medium according to claim 6, wherein the combination is calculated by solving the optimization problem subject to at least one of a price range, a possible price variation, and a time when a price is capable of changing, as a constraint.

8. The non-transitory storage medium according to claim 5, wherein the predicted value is computed using a specific prediction model.

9. A planning device for planning to order a product, the planning device comprising:
a memory; and
a processor coupled to the memory and configured to:
generate a predicted value of a demand of the product at each plurality of prices based on a selling price and a number of sales in association with each other for each past sale date,
calculate an order quantity that yields a highest profit, for each of the plurality of prices, using the predicted value of the demand of the product at the plurality of prices,
store, for the plurality of prices, the calculated order quantity and a profit in association with each other into the memory, and
identify a combination of a price and an order quantity that yields the highest profit, with reference to the memory.

10. The planning device according to claim 9, wherein the combination is calculated by solving an optimization problem of an objective function where the order quantity at each of the plurality of prices stored in the memory is an input and the profit is an output.

11. The planning device according to claim 10, wherein the combination is calculated by solving the optimization problem subject to at least one of a price range, a possible price variation, and a time when a price is capable of changing, as a constraint.

12. The planning device according to claim 9, wherein the predicted value is computed using a specific prediction model.
